(19) United States
(12) Patent Application Publication
(10) Pub. No.: US 2026/0273721 A1
(43) Pub. Date: Sep. 17, 2026

(54) TOOL HANDLE ATTACHMENT SYSTEM

(71) Applicant: Snap-on Incorporated, Kenosha, WI (US)

(72) Inventors: Marco E. DeVecchis, Kenosha, WI (US); Jonathan I. Andersen, Kenosha, WI (US)

(73) Assignee: Snap-on Incorporated, Kenosha, WI (US)

(21) Appl. No.: 19/076,496

(22) Filed: Mar. 11, 2025

(51) Int. Cl. B25G 3/12; B25G 1/10; B66F 15/00

(52) U.S. Cl. CPC B25G 3/12; B25G 1/102; B66F 15/00

(57) ABSTRACT

A tool handle attachment system includes a handle, a tool element, and a locking pin. A through hole may be formed through the handle, and a bore may be formed partially through the tool element, such that the bore does not pass completely through the entire tool element. The through hole and the bore may be aligned with one another and the locking pin disposed therein. The locking pin may prevent the handle from separating from the tool element during use of the hand-held tool assembly.

### TECHNICAL FIELD OF THE INVENTION

The present invention relates generally to an attachment system for hand-held tool handles. More particularly, the present invention relates to an attachment system for connecting a hand-held tool to a handle to provide increased holding power between the tool element and the handle.

### BACKGROUND OF THE INVENTION

Tools are often composed of two elements combined together, such as, for example, the tool element and a handle that is adapted to be held by a user. The tool element may include, for example, a screw driver, scraper device, pick, prybar, or any other type of tool. The tool elements are often constructed of metal, and the handle may be wood or plastic. During repetitive use, the handle may become lose or fall off of the metal tool element.

Typically, the metal tool element is attached to the handle via an interference fit or adhesive, but it is sometimes desirable to attach the tool element to the handle in a more secure manner to increase the holding power between the handle and the tool element. One example may be to use a locking pin with a hole drilled through the entirety of the handle and the tool element. However, this arrangement may result in the locking pin being pushed completely through the tool assembly.

### SUMMARY OF THE INVENTION

The present invention relates broadly to an attachment system for a hand-held tool handle to a tool. The attachment system may prevent slipping and/or detachment between the tool element and the handle.

In an embodiment, the present invention broadly relates to a hand-held tool assembly, including a tool element having a working end and a shaft, a bore disposed on the shaft, a handle having an outer wall and a cavity, a through hole formed in the outer wall and in communication with the cavity, and a locking pin, wherein the shaft is disposed in the cavity and the locking pin is disposed in the bore and the through hole, thereby fixedly coupling the handle to the tool element.

In another embodiment, the present invention broadly relates to a hand-held tool assembly, including a tool element having a working end and a shaft having a shaft cross-sectional size, a circumferential groove formed on the shaft, a retaining ring disposed in the circumferential groove, and a handle having opposing first and second ends, an outer wall, and a cavity extending between the first and second ends, wherein the cavity includes first and second portions respectively disposed adjacent to the first and second ends and respectively having first and second cross-sectional sizes, wherein the first cross-sectional size is substantially the same as the shaft cross-sectional size, and the second cross-sectional size is greater than the first cross-sectional size, thereby forming a shoulder between the first and second portions, wherein the shaft is disposed in the cavity adjacent to the first end and the retaining ring is radially aligned with the second portion in abutting engagement with the shoulder, thereby fixedly coupling the handle to the tool element.

In another embodiment, the present invention broadly relates to a hand-held tool assembly, including a tool element having a working end and a shaft having a shaft cross-sectional size, a circumferential groove formed on the shaft, a retaining ring disposed in the circumferential groove, a handle having opposing first and second ends, an outer wall, and a cavity extending between the first and second ends, wherein the cavity includes first and second portions respectively disposed adjacent to the first and second ends and respectively having first and second cross-sectional sizes, wherein the first cross-sectional size is substantially the same as the shaft cross-sectional size, and the second cross-sectional size is greater than the first cross-sectional size, thereby forming a shoulder between the first and second portions, and a cap disposed in the second portion adjacent to the second end of the handle wherein the shaft is disposed in the cavity adjacent to the first end, the retaining ring is radially aligned with the second portion adjacent to the shoulder, and the cap engages the shaft to cause the retaining ring to abut the shoulder, thereby fixedly coupling the handle to the tool element.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side view of an exemplar hand-held tool assembly, according to an embodiment of the present invention.

FIG. 2 is a disassembled view of the tool assembly of FIG. 1.

FIG. 3 is a partial section view of the tool assembly attachment of FIG. 1 taken along cutting section A-A of FIG. 2.

FIG. 4 is side view of another exemplar hand-held tool assembly, according to an embodiment of the present invention.

FIG. 5 is a disassembled view of the tool assembly of FIG. 4.

FIG. 6 is a partial section view of the tool assembly of FIG. 4 taken along cutting line B-B of FIG. 4.

FIG. 7 is side view of another exemplar hand-held tool assembly, according to an embodiment of the present invention.

FIG. 8 is a disassembled view of the tool assembly of FIG. 7.

FIG. 9 is a partial section view of the tool assembly of FIG. 7 taken along cutting line C-C of FIG. 7.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a hand-held tool handle attachment system that includes a handle, a tool element, and a locking pin. The tool element may include, for example, a screw driver, scraper device, pick, prybar, or any other type of hand-held tool. While the exemplary tool assembly may be depicted and/or described as a prybar, such is just exemplary, and does not limit the spirit and scope of the present invention.

The handle includes a cavity. The tool element includes a shaft which is shaped and sized so as to be inserted into the cavity formed in the handle. In prior art hand-held tool attachment systems, the shaft of the tool element may be retained within the handle cavity via interference fit or adhesives.

In an embodiment, a through hole may be formed through a portion of the handle to communicate with the cavity, and a bore may be formed partially through the tool element shaft, such that the bore does not pass completely through the entire tool element. The through hole and the bore may be substantially axially aligned with one another when the tool element is inserted into the handle. When axially aligned, a locking pin may be disposed in the through hole and the bore to couple the tool assembly to the handle. The locking pin may be coupled in the through hole and the bore with an interference fit, friction fit, adhesive or other means. The locking pin then prevents the handle from separating from the tool element during use of the tool assembly.

The tool handle attachment system results in increased holding power between the handle and the tool element, compared to prior art tools, such as using only an interference fit between the handle and the tool element. Further, by only forming the bore partially through the tool element, the tool handle attachment system may allow for a tool assembly with increased strength. Additionally, the bore being formed partially through the tool element negates the chances of the locking pin being unintentionally pushed through and out the opposing side of the bore.

In another embodiment, the present invention relates broadly to a tool handle attachment system that includes a handle, a tool element having a shaft, and a retaining ring. A circumferential groove may be formed in the outer surface of the tool element shaft which is shaped and sized to accept a retaining ring. The handle includes a cavity having first and second portions. The first portion has a first portion diameter that is substantially the same as the outer diameter of the tool element handle, thus creating a friction or interference fit when the handle is inserted into the cavity. The second portion has a diameter that is slightly larger than the first portion diameter, thus forming a shoulder between the first and second portions. When the tool assembly handle is inserted into the cavity, the circumferential groove is radially aligned with the second portion immediately adjacent to the shoulder. During assembly, an elastic retaining ring is disposed in the circumferential groove. As the tool assembly handle is inserted into the handle cavity, the retaining ring is deformed into the circumferential groove. When the tool handle is substantially fully inserted into the cavity, the circumferential groove is aligned with the second portion immediately adjacent the shoulder, thus allowing the retaining ring to elastically expand into the second portion. The tool assembly shaft is thus coupled to the handle by the retaining ring abutting the shoulder, which prevents the tool assembly from being removed from the handle. In an embodiment, a cap may be disposed in the second portion of the cavity to further depress the retaining ring against the shoulder. The cap may be press-fit, interferent fit, friction fit or threaded.

In an embodiment, the present invention relates broadly to a tool handle attachment system that includes a handle, a tool element having a shaft, and a retaining ring. A circumferential groove may be formed in the outer surface of the tool element shaft which is shaped and sized to accept an elastic retaining ring. An annular groove may be formed on an inner surface of the cavity. When the tool element shaft is inserted in to the handle cavity, the tool element shaft circumferential groove substantially radially aligns with the annular groove of the handle. During assembly of the tool assembly to the handle, a retaining ring may be disposed within the circumferential groove and elastically compressed as the tool element shaft is inserted into the cavity. When the tool element shaft is fully inserted in to the handle cavity, the tool element shaft circumference groove substantially radially aligns with the annular groove of the handle, allowing the retaining ring to elastically return to its biased shape so that the retaining ring is disposed in both the circumferential groove and the annular groove, thereby coupling the tool element to the handle.

The tool attachment system of the present invention may allow for increased retention strength between the handle and the tool element compared to tool assemblies known in the prior art.

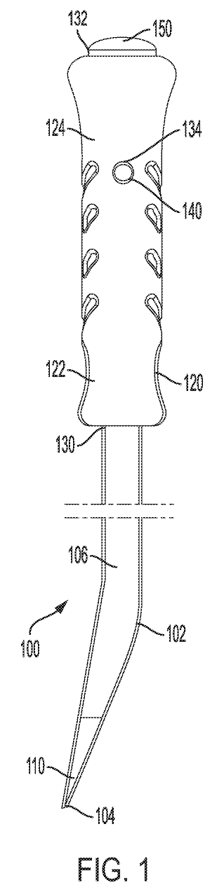

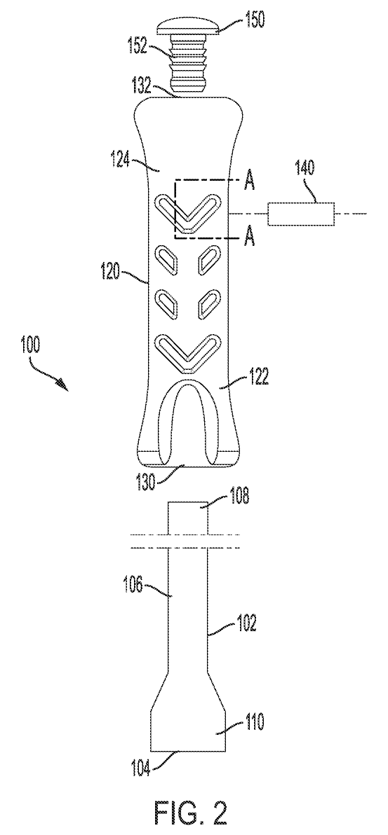

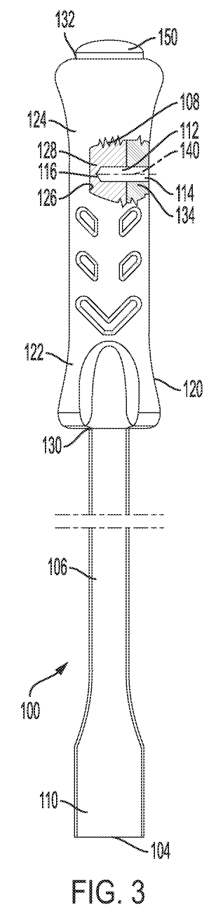

Referring to FIGS. 1-3, a hand-held tool assembly 100 is shown. The hand-held tool assembly 100 includes a tool element 102 and a handle 120. As illustrated, the tool element 102 is a prying element. However, it should be understood that, in embodiments, the tool element 102 may be any suitable type of tool element commonly used in handheld tools, including but not limited to a screw driver, scraper device, pick, or any other type of hand-held tool

The tool element 102 includes a working end 104, a shaft 106, and an insertion end 108 opposite of the working end 104. A prying tip 110 may be formed in the working end 104. The prying tip 110 may be used to pry or engage various work pieces, as will be understood by a person of skill in the art. While the prying tip 110 is shown with a specific shape and angle relative to the shaft 106, it should be understood that, in embodiments, the prying tip 110 may be formed in any suitable shape and/or angle.

As illustrated, the shaft 106 has a square cross-sectional shape. However, it should be understood that, in embodiments, the shaft 106 may have any suitably shaped cross-sectional shape, including but not limited to rectangular, circular, or any other suitable shape.

A bore 112 is formed in the shaft 106. The bore 112 may include an entry 114 and a bottom wall 116, such that the bore 112 does not pass completely through the shaft 106.

The handle 120 includes an outer wall 122. The outer wall 122 may include an outer surface 124 and an inner surface 126. The outer surface 124 may be adapted to be grasped by a hand of a user such as with an ergonomic shape so a user may handle the hand-held tool assembly 100. However, any other suitable shape may also be used.

The inner surface 126 defines an cavity 128. The cavity 128 may include a first opening 130 and a second opening 132 opposite of the first opening. The cavity 128 may be shaped and sized to accommodate the insertion end 108 of the tool element 102 into the first opening 130.

A through hole 134 is formed in the outer wall 122. When the tool element 102 is inserted into the cavity 128 the through hole 134 is aligned so as to be substantially axially aligned with the bore 112.

A locking pin 140 is inserted through the through hole 134 and disposed within the bore 112 when the through hole 134 and bore 112 are substantially axially aligned. The through hole 130, bore 112, and locking pin 140 may be shaped and sized so that the locking pin is press fit within the through hole 134 and the bore 112. In further embodiments, the locking pin 140 may be retaining within the through hole 134 and the bore 112 by any other suitable means, including but not limited to adhesives, welding, shims, or any other suitable means. The locking pin 140 retains the tool element 102 relative to the handle 120.

A cap 150 may be inserted into the second opening 132 of the cavity 128. The cap 150 may be adapted to be struck by an external device, such as a hammer, so as to transfer the energy to the tool element 102. In some embodiments, the cap 150 may be an interference fit within the cavity 128. In further embodiments, the cap 150 has one or more barbs 152 for retaining the cap 150 within the cavity 128. In yet further embodiments, the cap 150 may have a set of external threads which mates with a matching set of internal threads within the cavity 128.

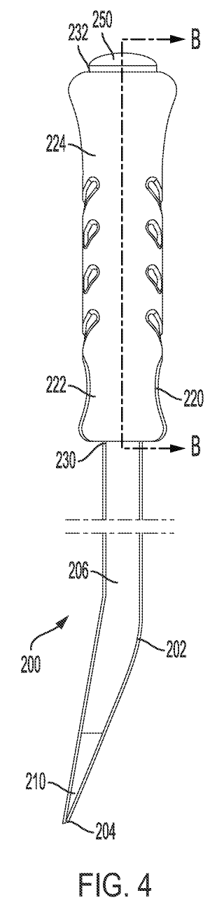

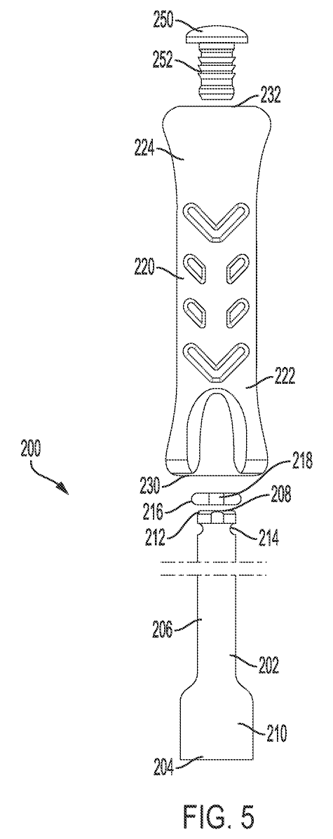

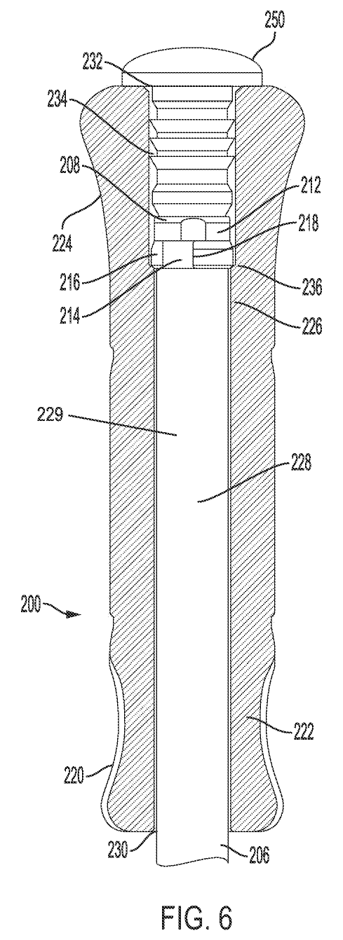

Referring now to FIGS. 4-6, a hand-held tool assembly 200 is shown. The hand-held tool assembly 200 includes a tool element 202 and a handle 220. The tool element 202 includes a working end 204, a shaft 206, and an insertion end 208 opposite of the working end 204. A prying tip 210 may be formed in the working end 204. The prying tip 210 may be used to pry or engage various work pieces, as will be understood by a person of skill in the art. While the prying tip 210 is shown with a specific shape and angle relative to the shaft 206, it should be understood that, in embodiments, the prying tip 210 may be formed in any suitable shape and/or angle.

As illustrated, the shaft 206 has a square cross-sectional shape. However, it should be understood that, in embodiments, the shaft 206 may have any suitably shaped cross-sectional shape, including but not limited to rectangular, circular, or any other suitable shape.

A cap 212 is formed proximate to the insertion end 208 of the tool element 202. A circumferential groove 214 is formed between the shaft 206 and the cap 212. The circumferential groove 214 may be formed with a semi-circular cross-sectional shape. In further embodiments, the circumferential groove 214 may have any other suitable cross-sectional shapes, including but not limited to square or rectangular.

The handle 220 includes an outer wall 222. The outer wall 222 may include an outer surface 224 and an inner surface 226. The outer surface 224 may be adapted to be grasped by a hand of a user such as with an ergonomic shape so a user may handle the hand-held tool assembly 200. However, any other suitable shape may also be used.

The inner surface 226 defines an cavity 228. The cavity 228 may include a first opening 230 and a second opening 232 opposite of the first opening 230. The cavity 228 includes a first portion 229 and a second portion 234.

The cavity 228 may be shaped and sized to accommodate the insertion end 208 of the tool element 202 into the first opening 230 and within the first portion 229. A second portion 234 is formed in the second opening 232. The second portion 234 has a shoulder 236. The shoulder 236 may be formed at an end of the second portion 234 to allow an object to rest thereon, as will be discussed in more detail below.

A retaining ring 216 is disposed within the circumferential groove 214. The retaining ring 216 may be biased outwardly. The retaining ring 216 may have a gap 218 which may allow the retaining ring 216 to be so as to be installed into the circumferential groove 214. In further embodiments, the retaining ring 216 may have additional features to allow for installation, including but not limited to mounting holes or ridges such that the retaining ring 216 may be handled by a tool, such as snap ring pliers. In some embodiments, the retaining ring 216 may be constructed of a hardened material, such as hardened steel.

As illustrated, the retaining ring 216 has a circular cross-sectional shape. However, it should be understood that, in further embodiments, the retaining ring 216 may have any other suitable cross-sectional shape, including but not limited to square, rectangular, or any other suitable shape.

During assembly of the tool assembly 200, the retaining ring 216 may be slotted within the circumferential groove 214 and elastically compressed as the tool shaft 206 is inserted into the cavity 228. When assembled, the circumferential groove 214 abuts the shoulder 236. The retaining ring 216 may then elastically expand outwardly into the annular groove 236. The retaining ring 216 may have a larger outer diameter than the shaft 206, and a smaller outer diameter than the shoulder 236, such that the retaining ring 216 retains the tool element 202 relative to the handle 220 by the retaining ring 216 engaging the shoulder 236 due to the size and outward bias nature of the retaining ring 216. The shoulder 236 and the retaining ring 216 may each be sufficiently sized so as to prevent slippage between the tool element 202 and the handle 220.

A cap 250 may be inserted into the second opening 232 of the cavity 228. The cap 250 may be adapted to be struck by an external device, such as a hammer, so as to transfer the energy to the tool element 202. In some embodiments, the cap 250 may be an interference fit within the cavity 228. In further embodiments, the cap 250 may have one or more barbs 252 for retaining the cap 250 within the cavity 228. In yet further embodiments, the cap 250 may have a set of external threads which mates with a matching set of internal threads within the cavity 228. In further embodiments, the cap 250 may be retained via interference fit, adhesives, or any other suitable means.

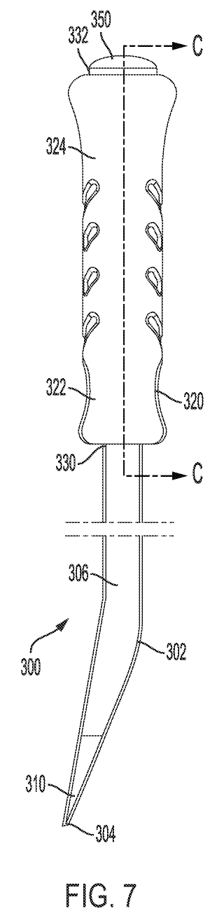

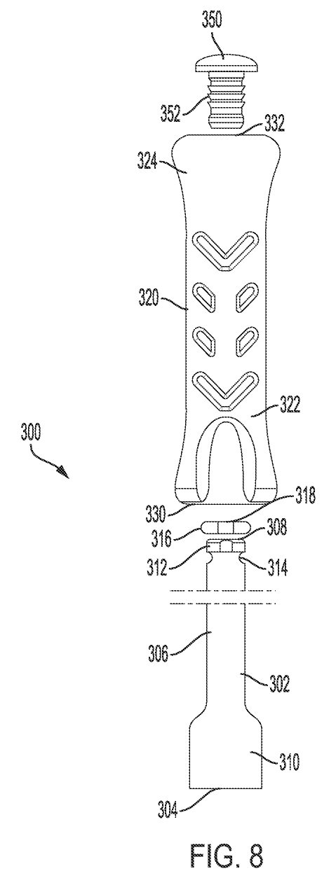

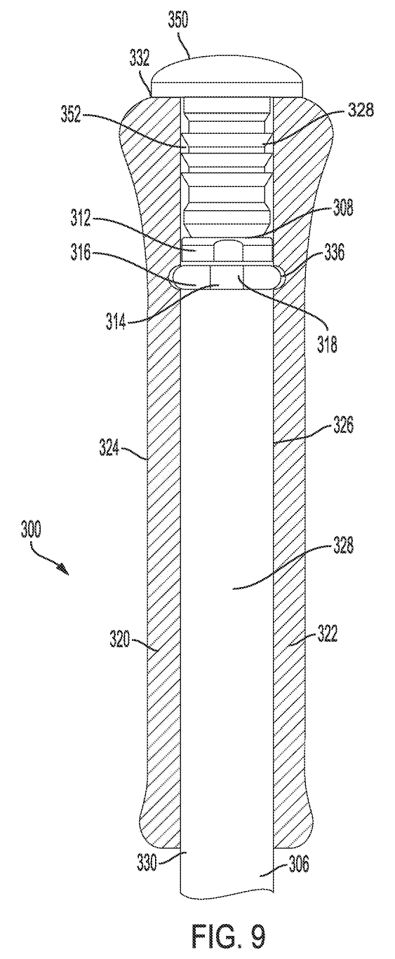

Referring now to FIG. 7-9, a hand-held tool assembly 300 is shown. The hand-held tool assembly 300 includes a tool element 302 and a handle 320. The tool element 302 includes a working end 304, a shaft 306, and an insertion end 308 opposite of the working end 304. A prying tip 310 may be formed in the working end 304. The prying tip 310 may be used to pry or engage various work pieces, as will be understood by a person of skill in the art. While the prying tip 310 is shown with a specific shape and angle relative to the shaft 306, it should be understood that, in embodiments, the prying tip 310 may be formed in any suitable shape and/or angle.

As illustrated, the shaft 306 has a square cross-sectional shape. However, it should be understood that, in embodiments, the shaft 306 may have any suitably shaped cross-sectional shape, including but not limited to rectangular, circular, or any other suitable shape.

A cap 312 is formed proximate to the insertion end 308 of the tool element 302. A circumferential groove 314 is formed between the shaft 306 and the cap 312. The circumferential groove 314 may be formed with a semi-circular cross-sectional shape. In further embodiments, the circumferential groove 314 may have any other suitable cross-sectional shapes, including but not limited to square or rectangular.

The handle 320 includes an outer wall 322. The outer wall 322 may include an outer surface 324 and an inner surface 326. The outer surface 324 may be adapted to be grasped by a hand of a user such as with an ergonomic shape so a user may handle the hand-held tool assembly 300. However, any other suitable shape may also be used.

The inner surface 326 defines an cavity 328. The cavity 328 may include a first opening 330 and a second opening 332 opposite of the first opening 330.

The cavity 328 may be shaped and sized to accommodate the insertion end 308 of the tool element 302 into the first opening 330. An annular groove 336 is formed in the cavity 328 to allow an object to be disposed therein, as will be discussed in more detail below.

A retaining ring 316 is disposed within the circumferential groove 314. The retaining ring 316 may be biased outwardly. The retaining ring 316 may have a gap 318 which may allow the retaining ring 316 to be deformed so as to be installed into the circumferential groove 314. In further embodiments, the retaining ring 316 may have additional features to allow for installation, including but not limited to mounting holes or ridges such that the retaining ring 316 may be handled by a tool, such as snap ring pliers. In some embodiments, the retaining ring 316 may be constructed of a hardened material, such as hardened steel.

As illustrated, the retaining ring 316 has a circular cross-sectional shape. However, it should be understood that, in further embodiments, the retaining ring 316 may have any other suitable cross-sectional shape, including but not limited to square, rectangular, or any other suitable shape.

During assembly of the tool assembly 300, the retaining ring 316 may be slotted within the circumferential groove 314 and elastically compressed as the tool shaft 306 is inserted into the cavity 328. When assembled, the circumferential groove 314 substantially radially aligns with the annular groove 336. The retaining ring 316 may then elastically expand outwardly into the annular groove 336. The retaining ring 316 may have a larger outer diameter than the shaft 306, and a smaller outer diameter than the annular groove 336, such that the retaining ring 316 retains the tool element 302 relative to the handle 320 by the retaining ring 316 engaging the annular groove 336. The annular groove 336 and the retaining ring 316 may each be sufficiently sized so as to prevent slippage between the tool element 302 and the handle 320.

A cap 350 may be inserted into the second opening 332 of the cavity 328. The cap 350 may be adapted to be struck by an external device, such as a hammer, so as to transfer the energy to the tool element 302. In some embodiments, the cap 350 may be an interference fit within the cavity 328. In further embodiments, the cap 350 may have one or more barbs 352 for retaining the cap 350 within the cavity 328. In yet further embodiments, the cap 350 may have a set of external threads which mates with a matching set of internal threads within the cavity 328. In further embodiments, the cap 350 may be retained via interference fit, adhesives, or any other suitable means.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors’ contribution. The actual scope of the protection sought is intended to be defined in the following claims when viewed in their proper perspective based on the prior art.

What is claimed is:

1. A hand-held tool assembly, comprising:
a tool element having a working end and a shaft;
a bore disposed on the shaft;
a handle having an outer wall and a cavity;
a through hole formed in the outer wall and in communication with the cavity; and
a locking pin,
wherein the shaft is disposed in the cavity and the locking pin is disposed in the bore and the through hole, thereby fixedly coupling the handle to the tool element.

2. The hand-held tool assembly of claim 1, wherein the bore radially extends partially in the shaft.

3. The hand-held tool assembly of claim 1, wherein the locking pin is press fit into the bore and the through hole.

4. The hand-held tool assembly of claim 1, wherein the locking pin is adhesively affixed in the bore and the through hole.

5. The hand-held tool assembly of claim 1, wherein the shaft and the cavity respectively have substantially square cross-sectional shapes.

6. The hand-held tool assembly of claim 1, wherein the handle includes an ergonomic shape.

7. The hand-held tool assembly of claim 1, wherein the tool element includes a prying element.

8. A hand-held tool assembly, comprising:
a tool element having a working end and a shaft having a shaft cross-sectional size;
a circumferential groove formed on the shaft;
a retaining ring disposed in the circumferential groove; and
a handle having opposing first and second ends, an outer wall, and a cavity extending between the first and second ends, wherein the cavity includes first and second portions respectively disposed adjacent to the first and second ends and respectively having first and second cross-sectional sizes, wherein the first cross-sectional size is substantially the same as the shaft cross-sectional size, and the second cross-sectional size is greater than the first cross-sectional size, thereby forming a shoulder between the first and second portions;
wherein the shaft is disposed in the cavity adjacent to the first end and the retaining ring is radially aligned with the second portion in abutting engagement with the shoulder, thereby fixedly coupling the handle to the tool element.

9. The hand-held tool assembly of claim 8, further comprising a cap disposed in the second portion adjacent to the second end of the handle and abutting the shaft to cause the retaining ring to abut the shoulder.

10. The hand-held tool assembly of claim 9, wherein the cap includes barbs and the cap is press fit into the second portion.

11. The hand-held tool assembly of claim 9, further comprising internal threads formed on the second portion of the cavity and corresponding external threads formed on the cap, wherein the cap is threadably engaged with the second portion.

12. The hand-held tool assembly of claim 8, wherein the shaft has a substantially square cross-sectional shape.

13. The hand-held tool assembly of claim 8, wherein the handle includes an ergonomic shape.

14. The hand-held tool assembly of claim 8, wherein the tool element includes a prying element.

15. A hand-held tool assembly, comprising:
a tool element having a working end and a shaft having a shaft cross-sectional size;
a circumferential groove formed on the shaft;
a retaining ring disposed in the circumferential groove;
a handle having opposing first and second ends, an outer wall, and a cavity extending between the first and second ends, wherein the cavity includes first and second portions respectively disposed adjacent to the first and second ends and respectively having first and second cross-sectional sizes, wherein the first cross-sectional size is substantially the same as the shaft cross-sectional size, and the second cross-sectional size is greater than the first cross-sectional size, thereby forming a shoulder between the first and second portions; and
a cap disposed in the second portion adjacent to the second end of the handle
wherein the shaft is disposed in the cavity adjacent to the first end, the retaining ring is radially aligned with the second portion adjacent to the shoulder, and the cap engages the shaft to cause the retaining ring to abut the shoulder, thereby fixedly coupling the handle to the tool element.

16. The hand-held tool assembly of claim 15, wherein the working end and the cavity respectively have corresponding angular shapes.

17. A hand-held tool assembly comprising:
a tool element having a working end and a shaft;
a circumferential groove formed on the shaft;
an elastic retaining ring disposed in the circumferential groove; and
a handle having an outer wall and a cavity, wherein the cavity includes an annular groove;
wherein the shaft is disposed in the cavity and the circumferential groove and the annular groove are substantially radially aligned so that the retaining ring engages both the circumferential groove and the annular groove, thereby fixedly coupling the handle to the tool element.

18. The hand-held tool assembly of claim 17, wherein the shaft has a substantially square cross-sectional shape.

19. The hand-held tool assembly of claim 17, wherein the handle includes an ergonomic shape.
